(19) United States
(12) Patent Application Publication
(10) Pub. No.: US 2013/0016588 A1
(43) Pub. Date: Jan. 17, 2013

(54) SYSTEM FOR INTERCHANGEABLE MOUNTING OPTIONS FOR A SONAR TRANSDUCER

(71) Applicant: Kyle D. O'Dell, Fort Gibson, OK (US)

(72) Inventor: Kyle D. O'Dell, Fort Gibson, OK (US)

(73) Assignee: NAVICO, INC., Tulsa, OK (US)

(21) Appl. No.: 13/183,034

(22) Filed: Jul. 14, 2011

(51) Int. Cl. G10K 11/00

(52) U.S. Cl. 367/173

(57) ABSTRACT

Systems and apparatuses for interchangeable mounting options for a transducer housing are provided herein. Such a system may provide for easy change of mounting to a watercraft, such as between transom mounting, portable mounting, trolling motor mounting, and thru-hull mounting. A system for interchangeable mounting options of a sonar transducer to a watercraft may comprise at least one transducer, a transducer housing configured to house the at least one transducer, and a mount adapter. The transducer housing may comprise at least one upper engagement surface configured to adjacently engage the mount adapter to facilitate mounting. The at least one upper engagement surface may be configured to releasably engage the mount adapter to allow the mount adapter to be detached and removed without damaging or altering the transducer housing.

### FIELD OF THE INVENTION

Embodiments of the present invention relate generally to mounting sonar transducers, and more particularly, to systems and apparatuses for interchangeable mounting options for a sonar transducer.

### BACKGROUND OF THE INVENTION

Sonar (SOund Navigation And Ranging) has long been used to detect waterborne or underwater objects. For example, sonar devices may be used to determine depth and bottom topography, detect fish, locate wreckage, etc. In this regard, due to the extreme limits to visibility underwater, sonar is typically the most accurate way to locate objects underwater. Sonar transducer elements, or simply transducers, convert electrical energy into sound or vibrations at a particular frequency. A sonar sound beam is transmitted into and through the water and is reflected from objects it encounters. The transducer receives the reflected sound (the “sonar returns”) and converts the sound energy into electrical energy. Based on the known speed of sound, it is possible to determine the distance to and/or location of the waterborne or underwater objects. The sonar return signals can also be processed to be displayed in graphical form on a display device, giving the user a “picture” of the underwater environment. The signal processor and display may be part of a unit known as a “sonar head” that is connected by a wire to the transducer mounted remotely from the sonar head. Alternatively, the sonar transducer may be an accessory for an integrated marine electronics system offering other features such as GPS, radar, etc.

Mounting of transducers may vary depending on a number of factors, including the design of the watercraft (e.g., boat or motor) to which it may be mounted. For example, a transducer may be mounted with a transom mounting, a portable mounting, a thru-hull mounting, a trolling motor mounting, an over-the-side mounting, or other hull or structure mounting options. Different mountings, however, require different features and often optimizing features for one type of mounting may create difficulties or be undesirable for another type of mounting.

### BRIEF SUMMARY OF THE INVENTION

Since different users need different kinds of mounting options for the sonar transducer, the manufacturer of sonar systems has to either sell the sonar head and the transducer separately, or cause the marine electronics dealer to inventory a number of versions of the same sonar system, the versions differing only in terms of the configuration of the transducer unit. These differences may be mechanical or electrical, or relate to the transducer's capabilities. However, selling the sonar head and transducer unit separately may be confusing for the consumer. One solution has been to sell the sonar system with the most popular type of transducer unit (e.g., configured for a transom mount) and allow the customer to exchange the transducer unit for another type if needed. This, however, requires extra effort for the customer and the dealer.

To avoid such problems and create ease for the customer, embodiments of the present invention provide systems and apparatuses for interchangeable mounting options for a transducer housing. Such a system may provide for interchangeable mounting options for watercraft, such as hull (e.g., transom) mounting, portable mounting, trolling motor mounting, and thru-hull mounting. In one example embodiment, a system for interchangeable mounting options of a sonar transducer to a watercraft is provided. The system may comprise at least one transducer, a transducer housing configured to house the at least one transducer, and a mount adapter. The transducer housing may comprise at least one upper engagement surface configured to adjacently engage the mount adapter to facilitate mounting. The at least one upper engagement surface may be configured to releasably engage the mount adapter to allow the mount adapter to be detached and removed without damaging or altering the transducer housing.

In another embodiment, a transducer housing configured for interchangeable mounting options for a boat is provided. The transducer housing is configured to house at least one transducer and comprises at least one upper engagement surface configured to adjacently engage a first mount adapter to facilitate a first type of mounting. The transducer housing further comprises at least one lower engagement surface configured to adjacently engage a second mount adapter to facilitate a second type of mounting as an alternative to the first type of mounting.

In yet another embodiment, a system for interchangeable mounting options of a sonar transducer to a boat is provided. The system comprises at least one transducer, a transducer housing configured to house the at least one transducer, and a trolling motor mount adapter. The transducer housing comprises at least one lower engagement surface configured to adjacently engage the trolling motor mount adapter to facilitate mounting on a trolling motor.

In another embodiment, a trolling motor mount adapter for a transducer housing configured for interchangeable mounting options for a boat is provided. The trolling motor mount adapter is configured to removably receive the transducer housing. The trolling motor mount adapter comprises a hole with a perimeter configured to engage the transducer housing such that the transducer housing fits at least partially in the hole.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram illustrating an example of a sonar transducer producing an array of sound waves from a boat;

FIG. 2 illustrates a system for mounting of a transducer housing on a boat hull (e.g., at the transom), in accordance with example embodiments described herein;

FIG. 2A shows a detail view of the system for transom mounting shown in FIG. 2, in accordance with example embodiments described herein;

FIG. 3 shows a perspective view of the system for transom mounting shown in FIG. 2, in accordance with example embodiments described herein;

FIG. 4 shows a perspective view of the transducer housing and transom mount adapter shown in FIG. 3, in accordance with example embodiments described herein;

FIG. 4A shows a cross-sectional view of the transducer housing and transom mount adapter along line 4A in FIG. 4, in accordance with example embodiments described herein;

FIG. 5 shows a perspective view of the transducer housing and transom mount adapter shown in FIG. 4, wherein the transom mount adapter is partially disengaged from the transducer housing, in accordance with example embodiments described herein;

FIG. 5A shows a cross-sectional view of the transducer housing and transom mount adapter along line 5A in FIG. 5, in accordance with example embodiments described herein;

FIG. 6 shows a perspective bottom view of the transducer housing and transom mount adapter shown in FIG. 5, in accordance with example embodiments described herein;

FIG. 7 shows a perspective view of the transducer housing shown in FIG. 4, in accordance with example embodiments described herein;

FIG. 7A shows a cross-sectional view of the transducer housing along line 7A in FIG. 7, in accordance with example embodiments described herein;

FIG. 8 illustrates a system for mounting a transducer housing to a kayak, in accordance with example embodiments described herein;

FIG. 8A shows a detail view of the system for mounting the transducer housing to the kayak shown in FIG. 8, in accordance with example embodiments described herein;

FIG. 8B shows a perspective view of a portion of the system for mounting the transducer housing to the kayak shown in FIG. 8, in accordance with example embodiments described herein;

FIG. 8C shows a cross-sectional view of the transducer housing and scupper mount adapter along line 8C in FIG. 8B, in accordance with example embodiments described herein;

FIG. 9 shows a detail view of another example of a system for mounting the transducer housing to the kayak shown in FIG. 8, in accordance with example embodiments described herein;

FIG. 10 illustrates a system for portable mounting of a transducer housing on a boat, in accordance with example embodiments described herein;

FIG. 10A shows a detail view of the system for portable mounting shown in FIG. 10, in accordance with example embodiments described herein;

FIG. 11 shows a perspective view of the transducer housing and portable mount adapter shown in FIG. 10, in accordance with example embodiments described herein;

FIG. 12 illustrates a system for mounting a transducer housing to a trolling motor, in accordance with example embodiments described herein;

FIG. 12A shows a detail view of the system for mounting a transducer housing to a trolling motor shown in FIG. 12, in accordance with example embodiments described herein;

FIG. 13 shows a perspective view of the trolling motor mount adapter shown in FIG. 12A, in accordance with example embodiments described herein;

FIG. 13A shows a perspective bottom view of the trolling motor mount adapter shown in FIG. 13, in accordance with example embodiments described herein;

FIG. 14 shows a perspective view of the transducer housing and trolling motor mount adapter shown in FIG. 12A, in accordance with example embodiments described herein;

FIG. 14A shows a perspective bottom view of the transducer housing and trolling motor mount adapter shown in FIG. 14, in accordance with example embodiments described herein;

FIG. 15 illustrates a system for thru-hull mounting a transducer housing to a boat, in accordance with example embodiments described herein;

FIG. 15A shows a detail view of the system for thru-hull mounting a transducer housing to the boat shown in FIG. 15, in accordance with example embodiments described herein; and

FIG. 16 illustrates an example method for changing mounting of a transducer housing from a transom mounting to a trolling motor mounting, in accordance with example embodiments described herein.

### DETAILED DESCRIPTION OF THE INVENTION

Exemplary embodiments of the present invention now will be described more fully hereinafter with reference to the accompanying drawings, in which some, but not all embodiments of the invention are shown. Indeed, the invention may be embodied in many different forms and should not be construed as limited to the exemplary embodiments set forth herein; rather, these embodiments are provided so that this disclosure will satisfy applicable legal requirements. Like reference numerals refer to like elements throughout.

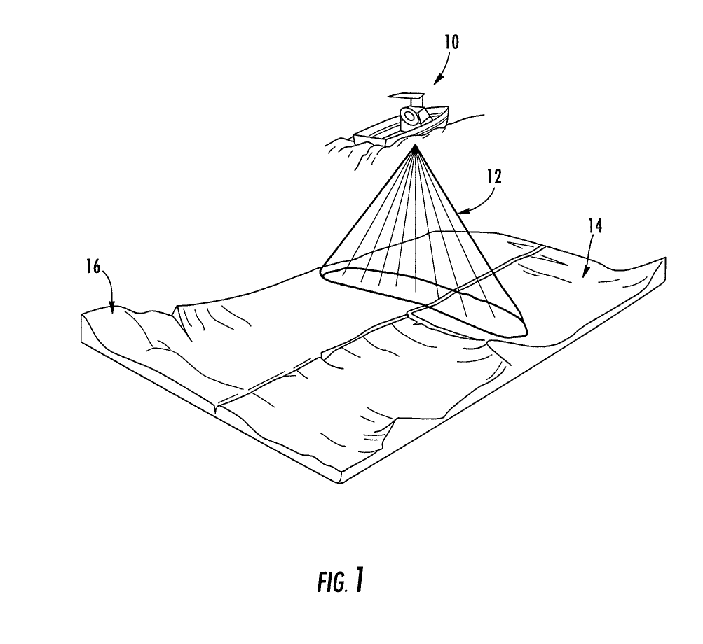

Sonar systems, such as sonar depth finders, sidescan sonars and sonar fish finders, are commonly employed by boaters, sport fishermen, search and rescue personnel, researchers, surveyors, and others. With reference to FIG. 1, a boat 10 may include a sonar system configured to create electrical pulses from a transmitter. A transducer then converts the electrical pulse into sound waves 12, which are sent into the water. In the depicted embodiment, a fan-shaped sound beam (e.g., a beam shape created from one or more rectangular transducers) is being transmitted into the water, however, as will be apparent to one of ordinary skill in the art in view of this disclosure, other sound beam configurations (e.g., conical shaped, multiple conical shaped, etc.) may be transmitted. Further information regarding different sonar transmissions is described in U.S. patent application Ser. No. 12/460,139, entitled “Downscan Imaging Sonar,” filed Jul. 14, 2009, and U.S. patent application Ser. No. 12/460,093, entitled “Circular Downscan Imaging Sonar,” filed Jul. 14, 2009, the entire disclosure of which are hereby incorporated by reference herein.

When the sound waves 12 strike anything of differing acoustic impedence, the sound waves 12 reflect off that object. These echos or sonar returns strike the transducer (or, in some cases, a separate receiver element), which converts the echos back into an electrical signal which is processed by a processor 23 and sent to a display (e.g., an LCD) mounted in the cabin or other convenient location in the boat. This process is often called “sounding”. Since the speed of sound in water is constant (approximately 4800 feet per second in fresh water), the time lapse between the transmitted signal and the received echos can be measured and the distance to the objects determined. This process repeats itself many times per second. The results of many soundings are used to build a picture on the display of the underwater world.

For example, the sound waves 12 may bounce off the floor 14 of the body of water and reflect back to the boat, thereby indicating a depth of the water at that location. Sometimes, the floor 14 may have an uneven topography (e.g., a raised surface 16) that may reflect different depths of the water at different locations. In such a circumstance, the sound waves 12 reflect off the various floor surfaces and back to the boat 10. Since the raised surface 16 is closer to the boat 10, the sound waves 12 will reach the boat 10 faster and indicate to the sonar system that the depth is shallower at raised surface 16 than at surface 14. Additionally, objects on the floor (e.g., sunken logs, rocks, wreckage of ships, etc.) reflect the sonar beams and are detected as topographical features. Fish in the water also create their own characteristic sonar returns.

The active element in a transducer may comprise at least one man-made crystal (e.g., lead zirconate or barium titanate). A conductive coating is applied to two sides of the crystal. Wires are soldered to these coatings so the crystal can be attached to a cable which transfers the electrical energy from the transmitter to the crystal. When the frequency of the electrical signal is the same as the mechanical resonant frequency of the crystal, the crystal moves, creating sound waves at that frequency. The shape of the crystal determines both its resonant frequency and cone angle. For round crystals, the thickness determines its frequency and the diameter determines the cone angle or angle of coverage. For example at 200 kHz, a 20 degree cone angle crystal is approximately one inch in diameter, whereas an eight degree cone requires a crystal that is about two inches in diameter. Sometimes it is desirable to have coverage which is wide in one direction (x axis) but narrow in the perpendicular direction (y axis). This fan shaped beam is usually produced by a rectangular element or an elliptical element. Moreover, in some embodiments, more than one transducer is used to create increased or enhanced sound wave coverage. Likewise, in some embodiments, more than one crystal may be used to create increased or enhanced sound wave coverage.

Frequencies used by sonar devices vary but the most common ones range from 50 KHz to 800 KHz depending on application. Some sonar systems vary the frequency within each sonar pulse using “chirp” technology. These frequencies are in the ultrasonic sound spectrum and are inaudible to both humans and fish.

Transducers come in all shapes and sizes. Most transducer housings for recreational boats are made from plastic, but some thru-hull transducer housings are made from bronze. In some cases, the size and shape of the transducer housing is determined by the size of the crystal inside and the shape required to have a smooth laminar flow of water over the face of the transducer so as to not create acoustical noise which can interfere with the returned echos. Additionally, however, the type of mounting required for each watercraft may be different, as some universal mountings provide less than desirable performance. For example, a trolling motor is designed to pass close to the surface under the water. Additionally, a transom mounted transducer may hang below the hull of the boat for better coverage area and less chance of interference with the boat. Therefore, converting a typical transom mount transducer to a trolling motor mount often results in a mount that is easily damaged by underwater debris or the floor when the boat is in very shallow water.

As such, embodiments of the present invention provide systems and apparatuses for interchangeable mounting options for a sonar transducer. In some embodiments, a transducer housing is provided for mounting to a watercraft or other waterborne object (e.g., towfish, surface tow board, submersible, remote operated vehicle, autonomous underwater vehicle, etc.). In some embodiments, a transducer housing is configured for hull mounting, transom mounting, troll motor mounting, portable mounting, and thru-hull mounting, eliminating the need to exchange transducer units. Additionally, in some embodiments, no fasteners or tools are required for changing between mounting options.

With reference to the figures, systems and apparatuses for mounting a transducer housing through transom mounting, thru-hull mounting, portable mounting, and trolling motor mounting will be described herein. As will be apparent to one of ordinary skill in the art in view of this disclosure, however, such systems and apparatuses may be used for other types of mounting to a watercraft. Additionally, some embodiments of the present invention are interchangeable between each of the different types of mountings, including those mounting types described herein. Moreover, while just one transducer is shown mounted in the referenced figures, some embodiments of the present invention may incorporate more than one transducer mounting for each watercraft.

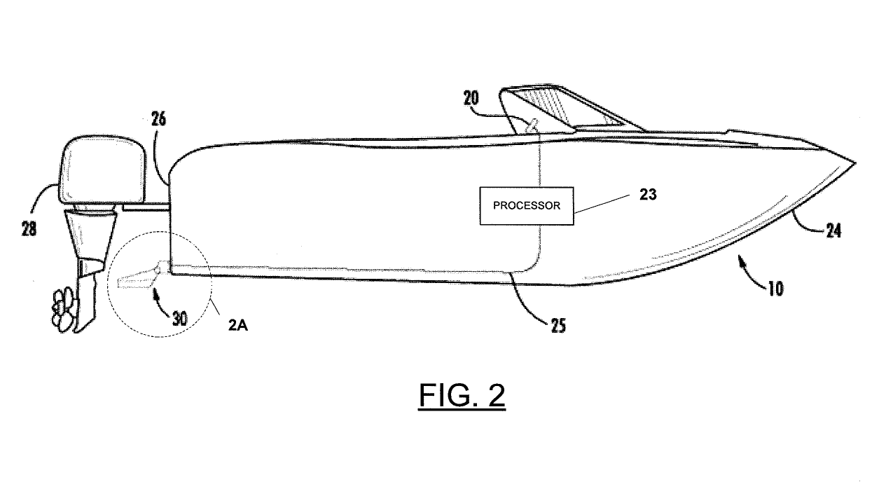

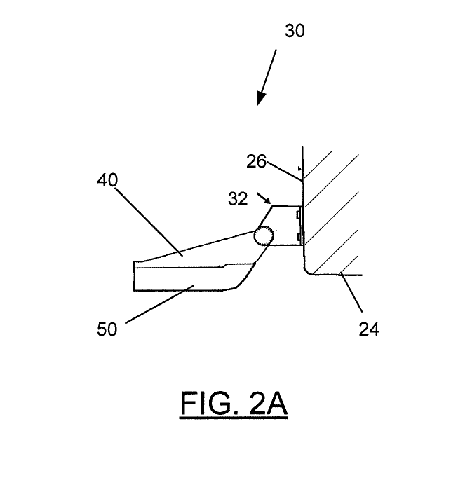

FIG. 2 illustrates a system 30 for mounting a transducer to the transom of a boat 10. In the depicted embodiment, the boat 10 includes a hull 24 and transom 26. An engine 28 is mounted near the transom 26 of the boat. The transducer is preferably mounted near the bottom of the transom of the boat 10, but may be attached to the hull in other locations. In some embodiments, as described above, a cable 25 may connect the transducer to a sonar signal processor 23, which in turn is connected to a sonar head 20. The sonar head 20 may include a display that provides an indication (e.g., depth, fish location, bottom topography, etc.) to a user/driver, as well as a user interface.

FIG. 2A represents a detailed view of the system 30 for mounting a transducer to the transom of a boat. In the depicted embodiment, a transom mounting bracket 32 attaches to the transom 26 of the boat 10. For example, the transom mounting bracket may be fastened to the transom of the boat, such as with screws, adhesive, or the like. In some embodiments, the cable 25 may be fed through the hull of the boat so as to connect to the sonar system on the boat, as noted above.

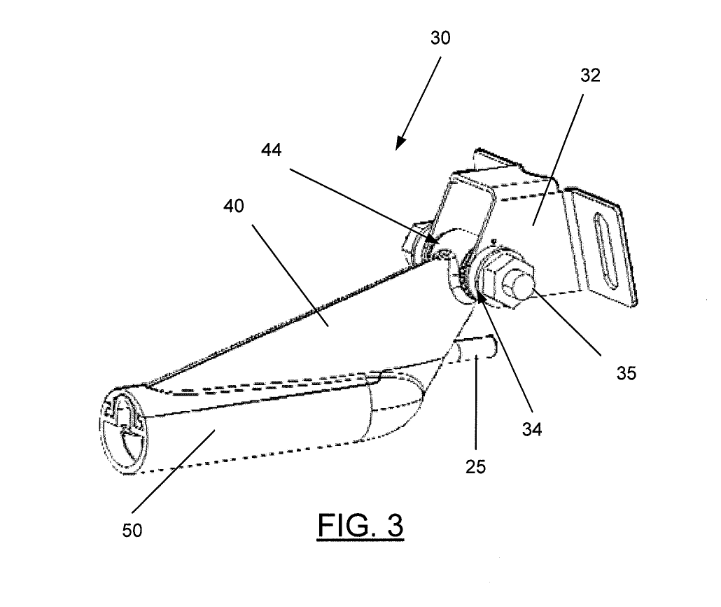

With reference to FIG. 3, the transom mounting bracket 32 may attach to a transom mount adapter 40. In some embodiments, the transom mounting bracket 32 comprises a transom mounting attachment feature 34 that is configured to attach to a corresponding attachment feature 44 on the transom mount adapter 40. In the depicted embodiment, a screw 35 securely fastens the transom mounting attachment feature 34 to the transom mount adapter attachment feature 44. In some embodiments, the transom mount adapter 40 (and transducer housing 50) may be rotatably attached to the transom mounting bracket 32.

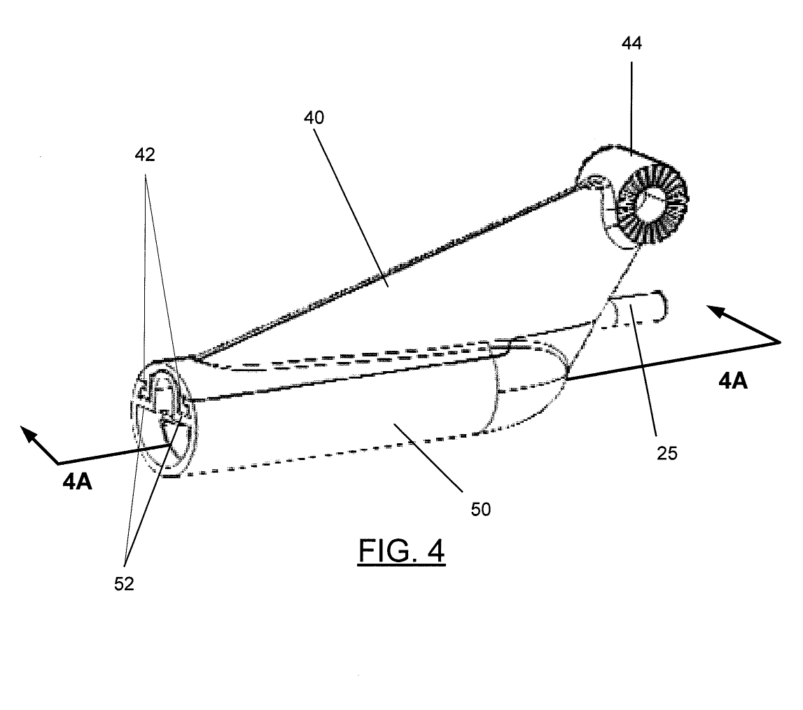

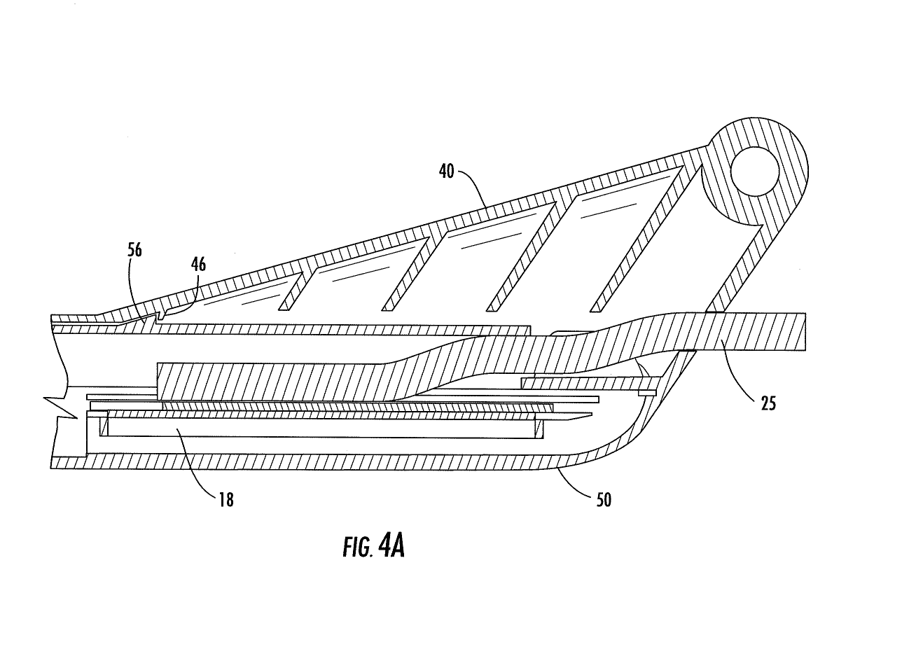

The transducer housing 50 may be configured to engage with the transom mount adapter 40. In some embodiments, the transducer housing 50 may be configured to removably engage with the transom mount adapter 40. As shown in FIGS. 4, 4A, 5, 5A, and 6, in some example embodiments, the transducer housing 50 may be configured to slidably engage the transom mount adapter 40. However, the transducer housing 50 may be configured to engage the transom mount adapter 40 in other ways, such as by clamping, fastening, adhering, or other engagement means.

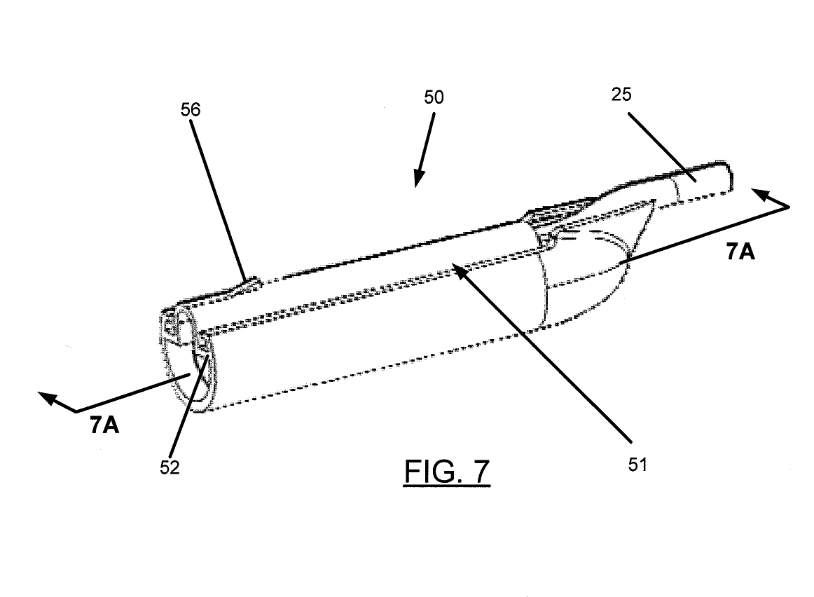

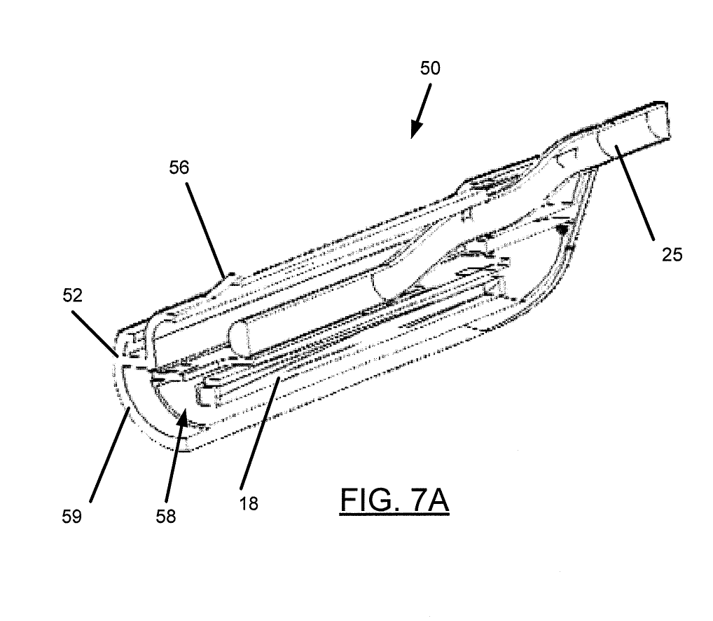

The transducer housing 50, as shown in FIGS. 7 and 7A, may be configured to hold at least one transducer. In the depicted embodiment, the transducer housing 50 is configured with a space 58 for the transducer/crystal 18. As noted above, however, in some embodiments, the transducer housing 50 may be configured to house more than one transducer/crystal. Moreover, in some embodiments, the transducer housing 50 may be configured to house different types and/or shapes of crystals (e.g., cylindrical, rectangular, etc.), or a combination of different types or shapes. For example, the transducer housing 50 may be configured to house multiple types of transducers, each of different configurations. Additionally or alternatively, in some embodiments, the transducer/crystal 18 may be separable from the transducer housing 50.

In some embodiments, the transducer housing 50 may be configured to house at least a portion of the cable 25. In the depicted embodiment, the transducer housing 50 may be configured such that the cable 25 may pass out the rear of the transducer housing 50. Feeding the cable 25 out of the rear of the transducer housing 50 may enable the cable 25 to be maneuvered or positioned easily and out of the way depending on the mounting option used for the transducer housing 50.

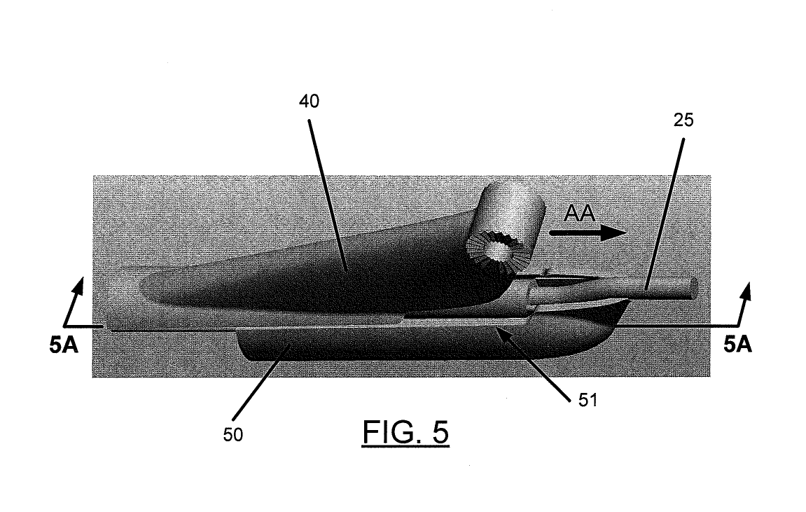

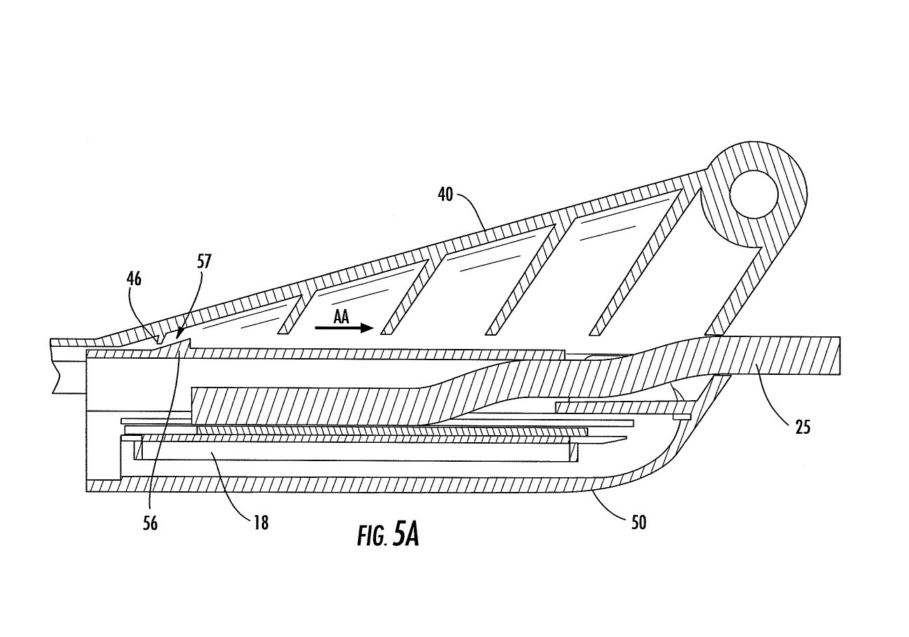

Returning now to an example of mounting the transducer housing to the transom of a boat, the transducer housing 50 may comprise an upper engagement surface 51 (shown in FIGS. 5 and 7). In some embodiments, the upper engagement surface 51 may be configured to adjacently engage the transom mount adapter 40.

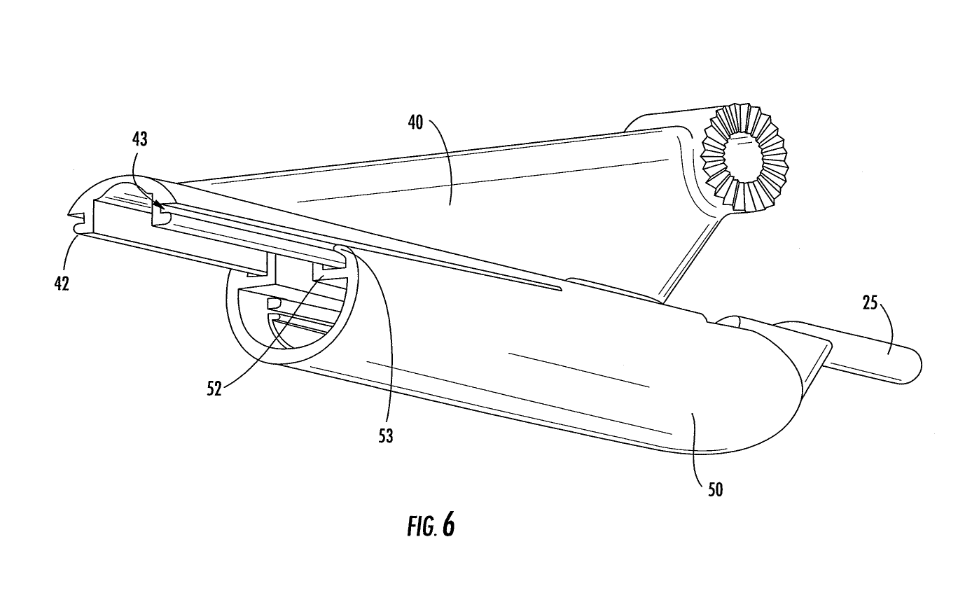

In an example embodiment, the transom mount adapter 40 may slidingly engage the transducer housing 50. For example, the upper engagement surface 51 may comprise an engagement feature 52 that corresponds to engagement features 42 on the transom mount adapter 40. The corresponding engagement features 42, 52 are configured to enable the transom mount adapter 40 to be slide into engagement with the transducer housing 50. For example, FIG. 6 illustrates that a slide flange 53 on the transducer housing 50 may fit into a slide flange receiving feature 43 on the transom mount adapter 40. In such a manner, the transom mount adapter 40 can be slide onto and into adjacent engagement with the transducer housing 50 (e.g., FIGS. 5, 5A, and 6 transition to FIGS. 4 and 4A, such as along line AA in FIG. 5). Though specific features are illustrated in the example embodiments of FIGS. 4, 4A, 5, 5A, and 6, other engagement means may be used for engagement of the transom mount adapter 40 to the transducer housing 50.

Additionally, in some embodiments, the transducer housing 50 may be configured to attach to the transom mount adapter 40. In some embodiments, the transducer housing 50 may be configured to removably attach to the transom mount adapter 40. In the depicted embodiments of FIGS. 4, 4A, 5, and 5A, the transducer housing 50 is configured to attach to the transom mount adapter 40 through a snap-fit engagement. For example, the transducer housing 50 may comprise a protrusion 56 configured to securely engage a locking feature 46 on the transom mount adapter 40 (shown attached in FIG. 4A) to prevent the transom mount adapter 40 from easily sliding out of engagement with the transducer housing 50. Moreover, in some embodiments, as shown in FIG. 5A, the protrusion 56 may comprise a tapered slope 57, such that the locking feature 46 on the transom mount adapter 40 may slide up the slope 57 and “snap” into position as the transom mount adapter 40 is engaged with the transducer housing 50, such as along line AA.

The transom mount adapter 40 may also be removed from the transducer housing 50, such as to provide for a different mounting option for the transducer housing 50. In some embodiments, the at least one upper engagement surface of the transducer housing 50 may be configured to releasably engage the transom mount adapter 40 to allow the transom mount adapter 40 to be detached and removed without damaging or altering the transducer housing 50. For example, in some embodiments, to remove engagement with the transom mount adapter 40, the transom mount adapter 40 may be slide in the opposite direction of line AA. Additionally or alternatively, the transom mount adapter 40 may be lifted or slightly maneuvered to dislodge attachment of the protrusion 56 to the locking feature 46. In such a manner, snap-fit engagement may provide a means for removable attachment of the transducer housing 50 to the transom mount adapter 40. Moreover, in some embodiments, such engagement may be achieved without fasteners or adhesive bonding, and without tools.

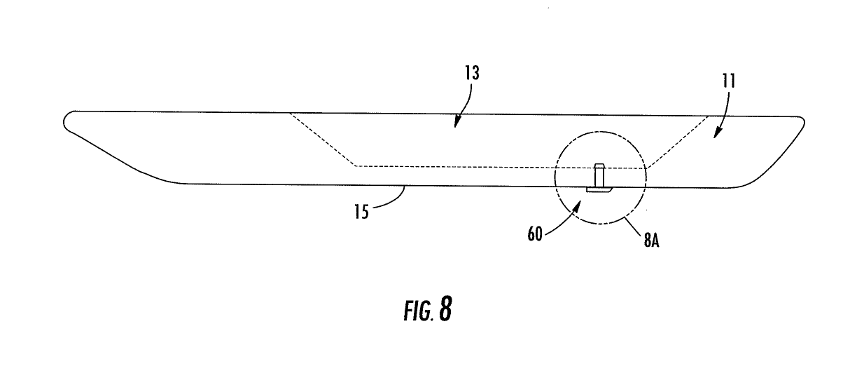

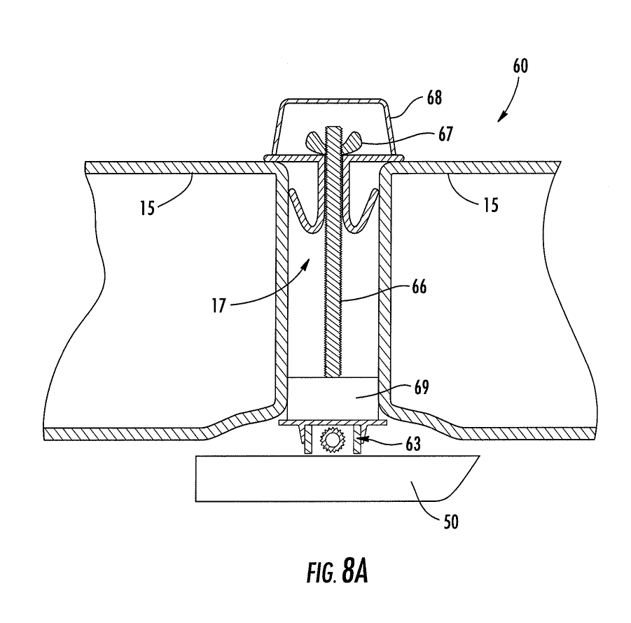

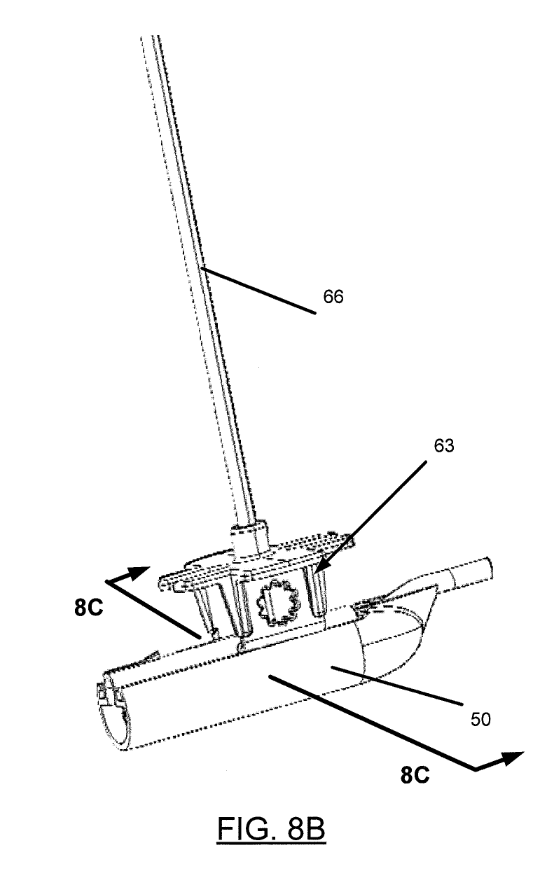

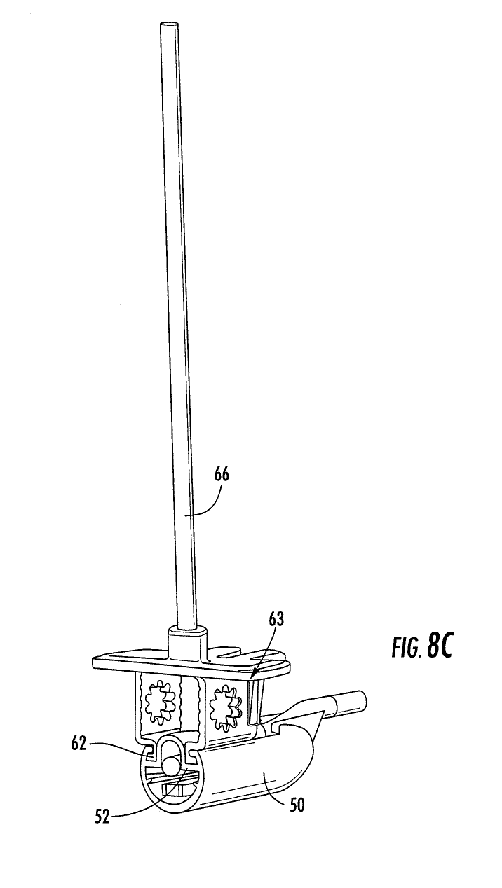

FIG. 8 illustrates a system 60 for mounting a transducer through the hull of a kayak 11. In the depicted embodiment, the transducer is mounted through a scupper hole in the hull 15 of the kayak 11. For example, kayaks often have at least one scupper hole for draining of water that may be inside the kayak, such as from the sitting portion 13 of the kayak 11. Therefore, a mounting system (e.g., the thru-hull mounting system 60) may be positioned through the scupper hole to mount a sonar transducer to a kayak. Since kayaks often do not have as strict of requirements for keeping water out, in some embodiments, sealing elements (e.g., washers, adhesive, caulking, etc,) may not be necessary for the mounting system.

FIG. 8A represents a detailed view of the system 60 for mounting a transducer through the scupper hole 17 of the kayak 11. In the depicted embodiment, a screw 66 passes through the scupper hole 17 of the hull 15. The screw 66 is attached to a kayak mounting adapter 63. A washer 69 may also be positioned between the kayak mounting adapter 63 and the hull of the boat to provide sealing and to maintain the position of the screw 66 inside the scupper hole 17. Additionally, in some embodiments, a nut 67 may tighten onto the screw 66 to fasten the kayak mounting adapter 63 to the kayak 11. In some embodiments, a protective cap 68 may be positioned around the nut 67 and/or screw 66 for protection and/or aesthetic purposes.

With further reference to FIGS. 8B and 8C, the kayak mounting adapter 63 may comprise engagement features 62 that correspond to and are configured to engage with the engagement features 52 of the transducer housing 50. Thus, in some embodiments, the kayak mounting adapter 63 is configured to slidingly engage with the transducer housing 50. In some embodiments, other locking features may be employed to attach the kayak mounting adapter 63 to the transducer housing 50 (e.g., snap-fit engagement, etc.).

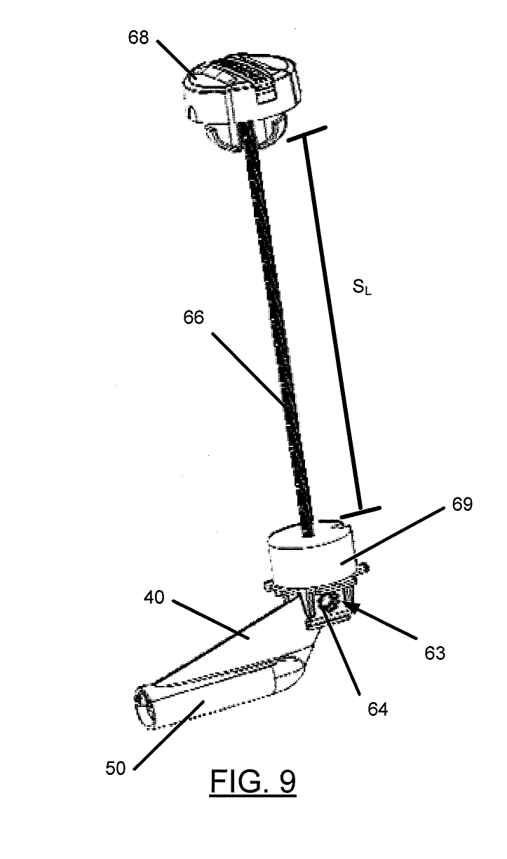

Some kayaks, however, may require additional clearance for the transducer housing 50 (and transducer) due to inconsistencies in the hull 15 that may cause interference with the transducer. As such, additional mounting features may be employed to lower the transducer further below the hull 15. For example, in some embodiments, the kayak mounting adapter 63 may comprise an attachment feature 64 (shown in FIG. 9) configured to attach to an adapter (e.g., the transom mount adapter 40). The adapter may be engaged with the transducer housing 50 such that the transducer housing 50 (and transducer) becomes mounted to the kayak. In the depicted embodiment of FIG. 9, the screw 66 may pass through the scupper hole 17 of the hull 15. For example, the screw 66 may pass through a length (S_{L}) of the hull of the kayak. In such a manner, the same transom mount adapter 40, used for transom mounting to a boat, may also be used for mounting a transducer to a kayak. Such an embodiment illustrates an example system of interchangeable mounting options for the transducer housing.

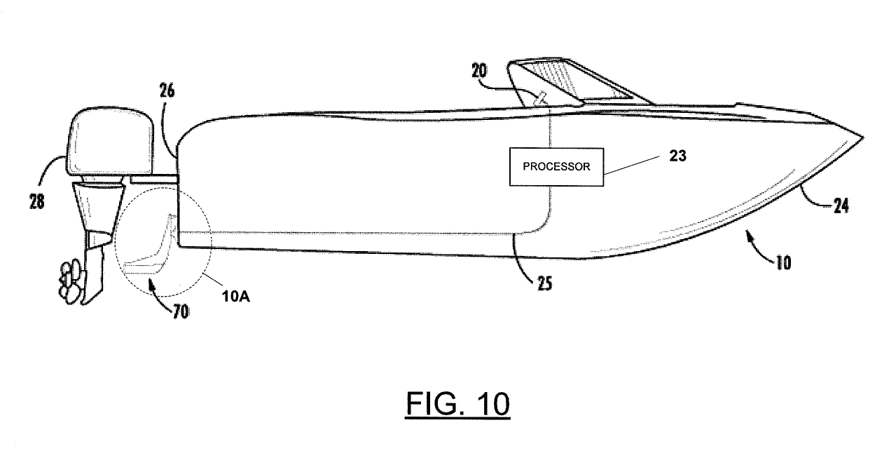

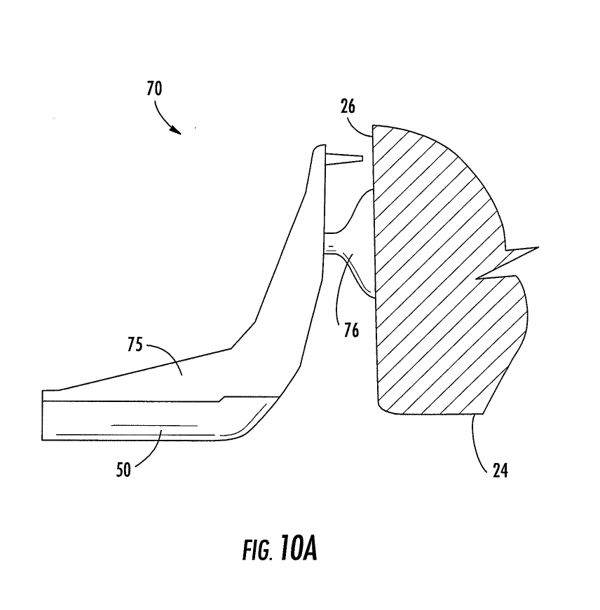

FIG. 10 illustrates a system 70 for portable mounting of a transducer to the transom of a boat 10. In the depicted embodiment, the transducer is mounted with a suction cup near the bottom of the transom of the boat 10. In some embodiments, as described above, a cable 25 may connect the transducer to a sonar head 20 and/or processor 23.

FIG. 10A represents a detailed view of the system 70 for portable mounting of a transducer to the transom of a boat. In the depicted embodiment, a portable mounting adapter 75 comprises a suction cup 76, which attaches to the transom 26 of the boat 10 (e.g., through suction or pressure mounting). In other embodiments, the portable mount adapter 75 may comprise more than one suction cup or other attachment means that allow for easy detachment and mobility.

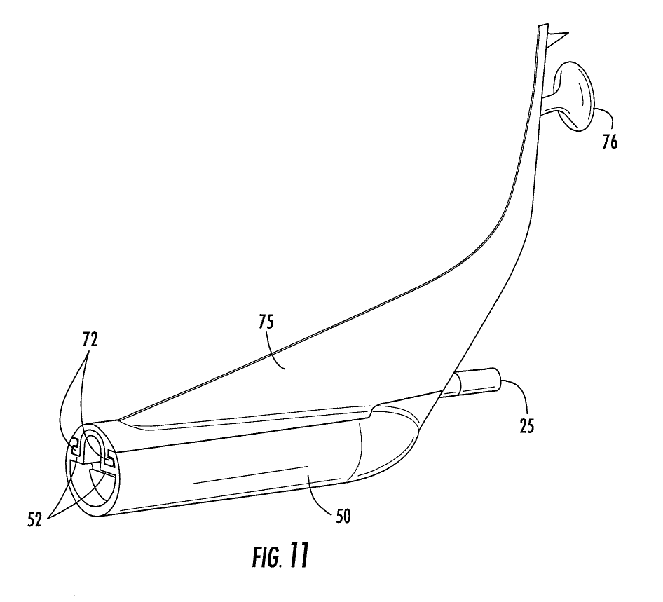

With reference to FIG. 11, the portable mount adapter 75 may be engaged with the transducer housing 50 in a similar manner to that of the transom mount adapter 40 described above. For example, the portable mount adapter 75 may comprise engagement features 72 that correspond to engagement features 52 on the transducer housing 50. Moreover, the portable mount adapter 75 may comprise other features that enable slidable and/or removable engagement with the transducer housing 50 (e.g., a slide flange receiving feature similar to the slide flange receiving feature 43 of the transom mount adapter).

Likewise, in some embodiments, the portable mount adapter 75 may be configured to attach to the transducer housing 50, such as through snap-fit engagement. For example, the portable mount adapter 75 may comprise a locking feature (similar to the locking feature 46 of the transom mount adapter 40) that corresponds to and engages with the protrusion 56 of the transducer housing 50. As such, in some embodiments, the portable mount adapter 75 may slide onto and snap into attachment with the transducer housing 50. Therefore, example embodiments for portable mounting illustrate another example of the interchangeable mounting options of embodiments of the present invention.

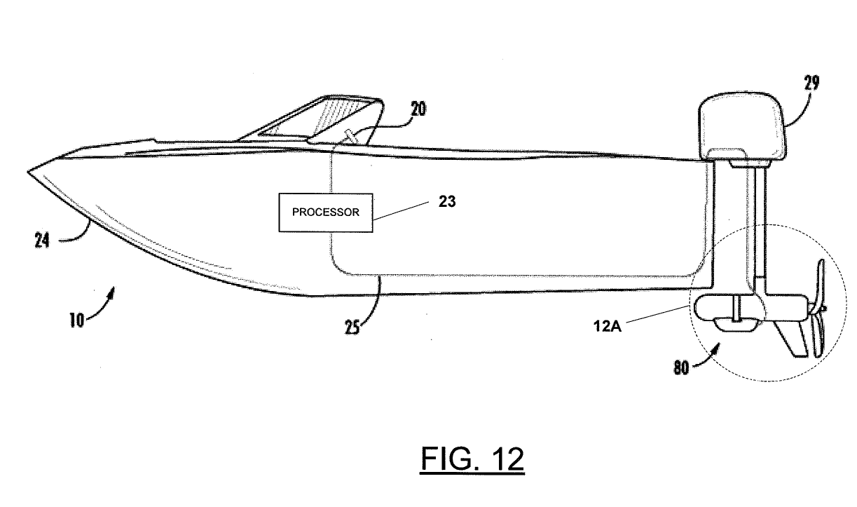

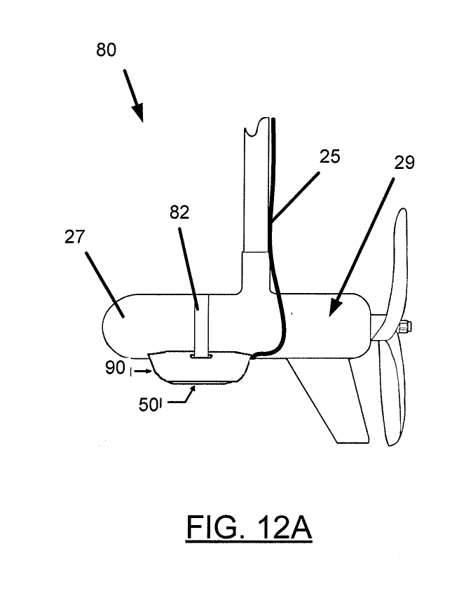

FIG. 12 illustrates a system 80 for mounting of a transducer to a trolling motor. In the depicted embodiment, the transducer is mounted directly to a trolling motor 29 attached to a boat 10. Trolling motors often extend below the hull 24 of the boat 10. Also, trolling often occurs in shallow waters and, thus, as noted above, transducers mounted to the housing of a trolling motor may be more likely to encounter objects (e.g., rocks) or the surface below the water.

Similar to embodiments described above, a cable 25 may connect the transducer to a sonar display 20 or sonar return processor 23. As shown in FIGS. 12 and 12A, the cable 25 may follow the housing of the trolling motor 29 and feed into the boat 10 and to the sonar head 20.

FIG. 12A represents a detailed view of the system 80 for mounting of a transducer to a trolling motor. In the depicted embodiment, a trolling motor mount adapter 90 contains at least a portion of the transducer housing 50. The trolling motor mount adapter 90 is attached to the trolling motor 29 via a hose clamp (or strap) that is secured around a cylindrical housing 27 of the trolling motor 29.

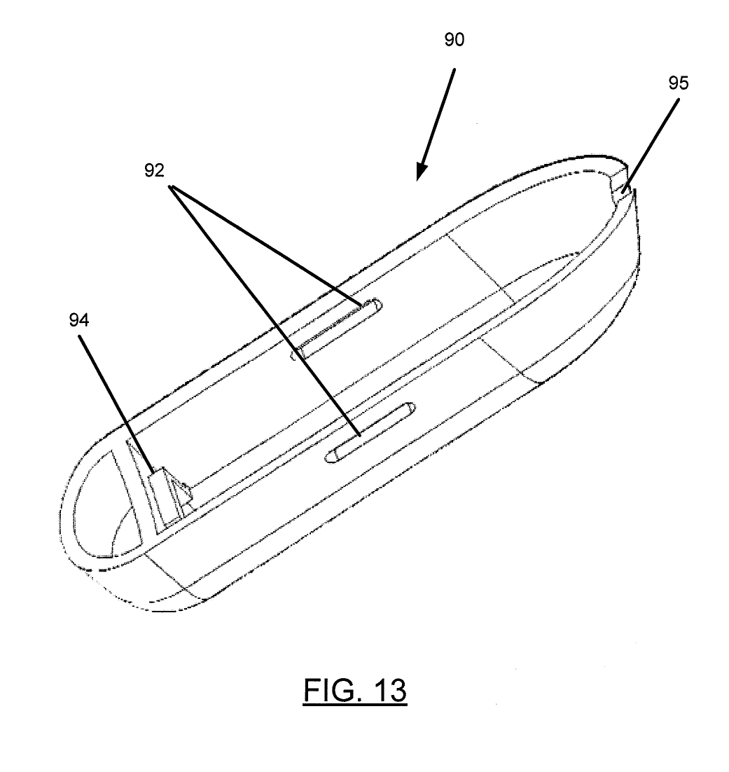

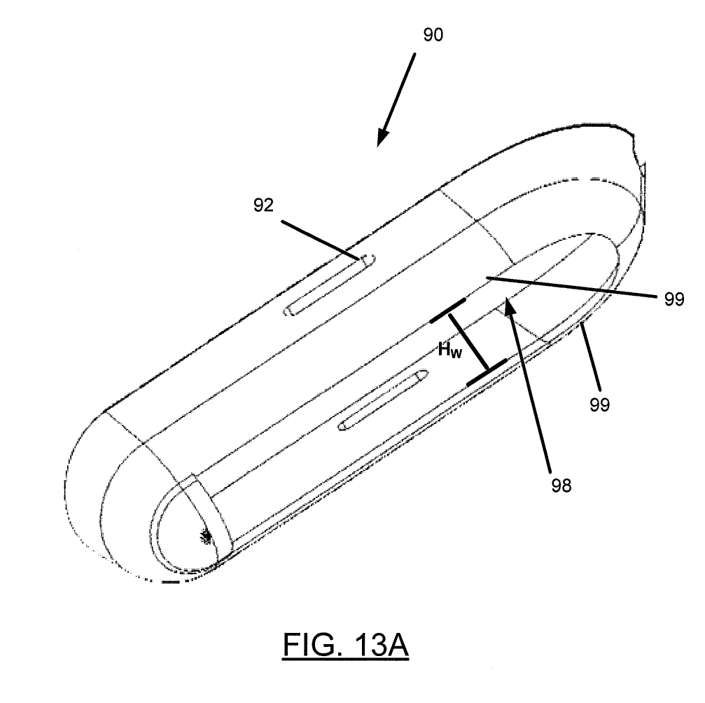

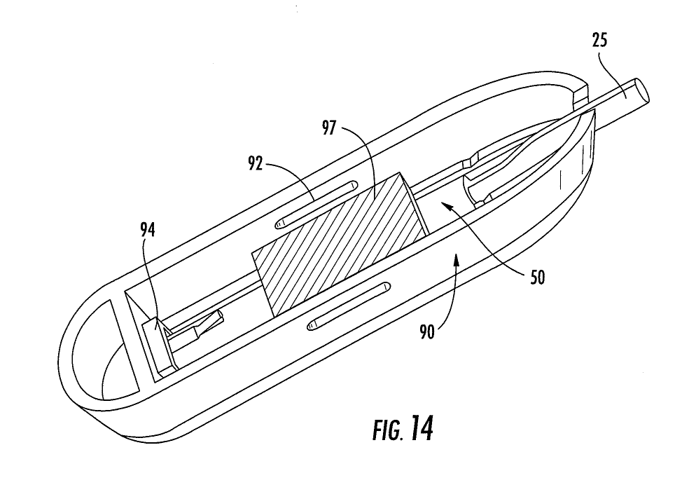

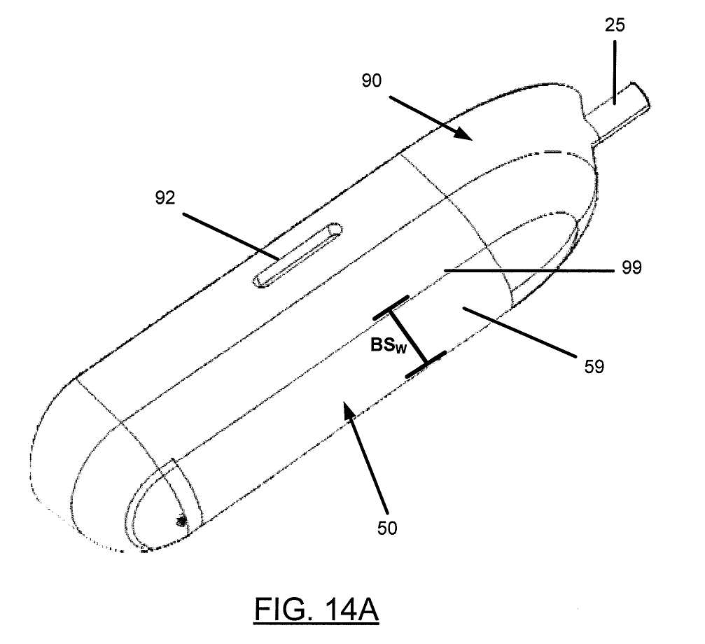

The trolling motor mount adapter 90 may be configured to receive the transducer housing 50 (shown in FIGS. 14 and 14A). As such, with reference to FIG. 13A, the trolling motor mount adapter 90 may comprise a hole 98. The hole 98 may comprise a perimeter 99 that has an area that is smaller than the bottom surface 59 of the transducer housing 50. For example, the width of the hole of the trolling motor mount adapter (H_{W}) may be less than the width of the bottom surface of the transducer housing (B S_{W}) (shown in FIG. 14A) such that at least a portion of the transducer housing 50 may fit into the trolling motor mount adapter without falling through the hole 98. As such, the perimeter 99 of the hole 98 may form an engagement surface for the transducer housing 50. Having direct access to the water for at least a portion of the transducer housing 50 through the hole 98 allows the transducer/crystal in the transducer housing 50 the ability to send out sound waves to perform the desired measurements (e.g., “sounding”).

In some embodiments, the trolling motor mount adapter 90 may comprise an engagement surface configured to receive at least a portion of the transducer housing 90 to facilitate engagement therebetween. In the depicted embodiment of FIG. 14, the trolling motor mount adapter comprises a protrusion or tab 94 that forms a securing feature for a portion of the upper surface of the transducer housing 50 to secure into. As such, one end of the transducer housing 50 may be fit into the tab 94 and then the reminder of the transducer housing 50 may be rotated downward into place within the trolling motor mount adapter 90.

Once the transducer housing 50 has been engaged with the trolling motor mount adapter 90, the trolling motor mount adapter 90 may be fastened to the trolling motor (shown in FIG. 12A). In some embodiments, the trolling motor mount adapter 90 may comprise at least one slot 92 configured to receive a hose clamp or other mounting strap 82. As noted above, the strap 82 may then be tightened around a portion of the trolling motor 29 to secure the trolling motor mount adapter 90 and transducer housing 50 to the motor.

Securing the transducer housing 50 and trolling motor mount adapter 90 to the motor with the strap 82, however, may leave the transducer housing 50 not fully protected. For example, space may remain between the transducer housing 50 and the motor 29 allowing the transducer housing 50 to shift during movement, such as an impact with the bottom surface or an object in the water. As such, in some embodiments, a padding 97 (e.g., closed cell pad) may be positioned between the transducer housing 50 and the trolling motor 29 to at least partially protect and/or cushion the transducer and transducer housing 50.

As noted above, the close proximity of the bottom surface and objects in the water make maintaining a small form factor for mounting transducer housings to a trolling motor desirable. However, connecting a cable (e.g., cable 25) to the transducer may also be required. As such, in some embodiments, the trolling motor mount adapter 90 may comprise a notch or other feature 95 that enables the cable 25 to pass through the trolling motor mount adapter 90 without causing the transducer housing 50 and trolling motor mount adapter 90 to unnecessarily extend further below the trolling motor 29.

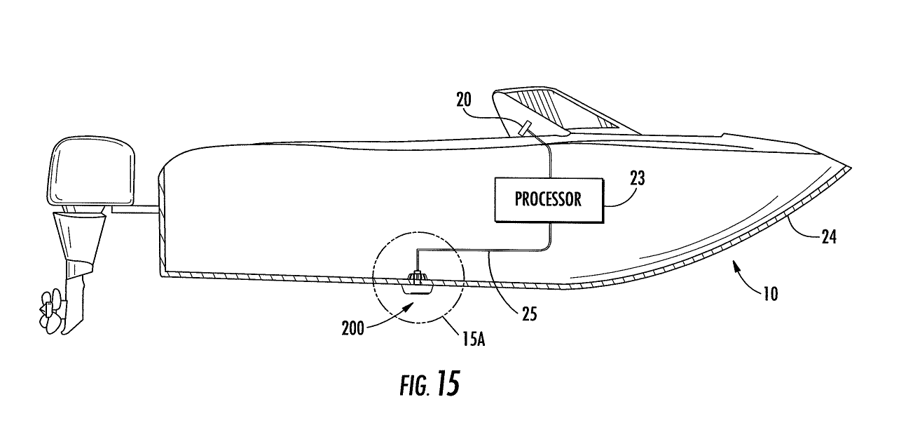

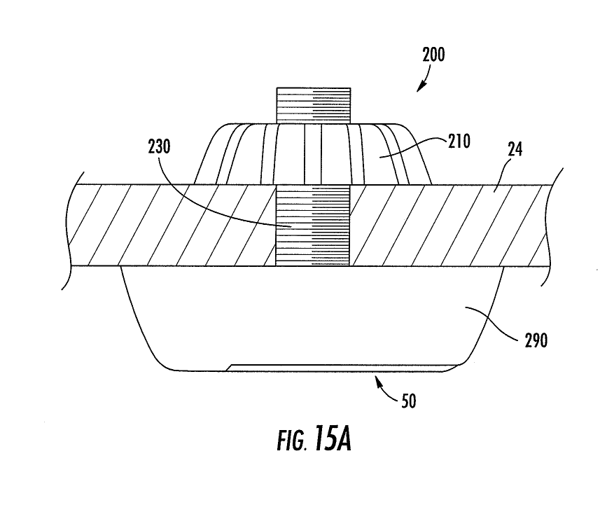

FIG. 15 illustrates an example system 200 for mounting a transducer through the hull of a boat 10. In the depicted embodiment, the transducer is mounted through the hull 24 of the boat 10. In some embodiments, as described above, a cable 25 may connect the transducer to a processor 23 and/or sonar head 20 having a display providing an indication (e.g., depth, fish location, etc.) to a user/driver.

FIG. 15A represents a detailed view of the system 200 for mounting a transducer through the hull of a boat. In the depicted embodiment, a screw 230 passes through the hull 24. A nut 210 or other securing features may secure the screw 230 from inside the boat. Additionally, in some embodiments, sealing elements (e.g., washers) may be positioned around the screw 230 to prevent water from leaking through the screw hole in the hull of the boat. In the depicted embodiment, the transducer housing 50 is positioned inside a thru-hull mount adapter 290. In some embodiments, the thru-hull mount adapter 290 may comprise similar features to the previously described trolling motor mount adapter 90. As such, in some embodiments, the transducer housing 50 may be configured to adjacently engage the thru-hull mount adapter 290, such as with a lower engagement surface. Additionally, in some embodiments, similar to the trolling motor mount adapter, the thru-hull mount adapter 290 may comprise a hole for receiving at least a portion of the transducer housing 50 such that the transducer housing 50 may contact the water in order to transmit sound waves.

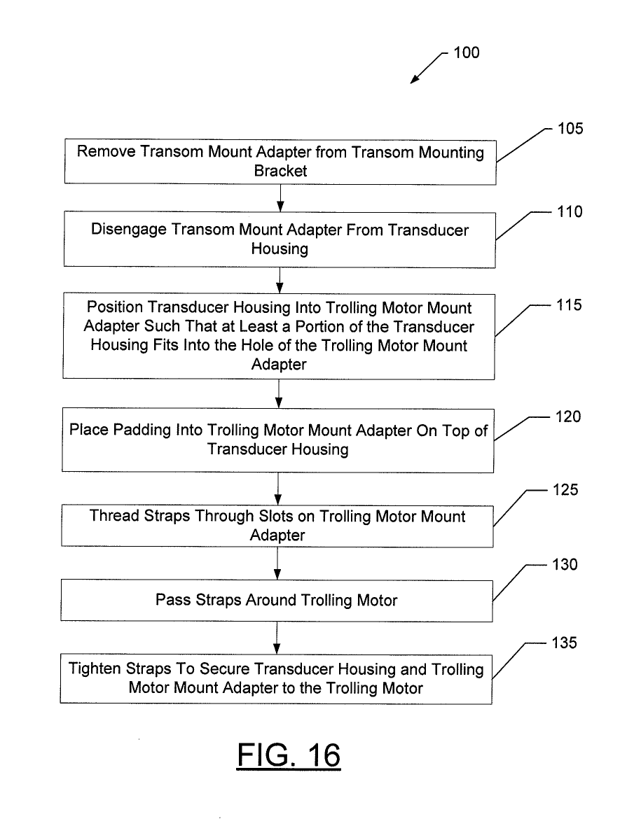

As described herein, embodiments of the present invention provide systems and apparatuses for interchangeable mounting options for a transducer housing. As such, example descriptions of certain mounting options contain a common transducer housing 50 that may be interchangeable between the described mounting options. While FIG. 16 illustrates one example method for changing a transducer housing from a transom mounting to a trolling motor mounting, other methods are contemplated for changing mounting options for the transducer housing between various combinations of the mounting systems described herein.

FIG. 16 illustrates a flow chart of an example method 100 of changing a transducer housing from a transom mounting to a trolling motor mounting. At operation 105, the transom mount adapter may be removed from the transom mounting bracket. Then, at operation 110, the transom mount adapter may be disengaged (e.g., slide off) from the transducer housing. The transducer housing may next be placed into the trolling motor mount adapter such that at least a portion of the bottom surface of the transducer housing fits into the hole of the trolling motor mount adapter at operation 115. Next, at operation 120, a padding may be placed into the trolling motor mount adapter on top of the transducer housing. Straps, or a hose clamp, may then be thread through the slots of the trolling motor mount adapter at operation 125. After that, at operation 130, the straps (or hose clamp) may be passed around the trolling motor. Finally, at operation 135, the straps (or hose clamp) may be tightened to effect securing and mounting of the transducer housing to the trolling motor.

Embodiments of the present invention provide a number of advantages. For example, systems and apparatuses are provided herein for interchangeable mounting options for a transducer housing. As such, a customer can simply purchase a kit for trolling motor mounting, portable mounting, or thru-hull mounting which attaches to the transducer included with the sonar. Moreover, in some embodiments, there is no compromise in performance over a transducer designed for a single mounting method. For example, the water resistance and turbulence caused by each mounting method is at least as small as with a transducer designed for a single mounting method. The added parts required add minimum cost and assembly for each mounting method. Additionally, assembly is no more complicated than what is required for a transducer designed for a single mounting method. In some embodiments, the transom mount adapter (and portable mount adapter) easily slides onto the transducer housing and snaps in place. Additionally, in some embodiments, no tools are required to attach the two parts to each other.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for interchangeable mounting options of a sonar transducer to a watercraft, the system comprising:
at least one transducer;
a transducer housing configured to house the at least one transducer; and
a mount adapter, wherein the transducer housing comprises at least one upper engagement surface configured to adjacently engage the mount adapter to facilitate mounting, and wherein the at least one upper engagement surface is configured to releasably engage the mount adapter to allow the mount adapter to be detached and removed without damaging or altering the transducer housing.

2. The system according to claim 1, wherein the mount adapter is configured to slidably engage the at least one upper engagement surface of the transducer housing.

3. The system according to claim 1, wherein the mount adapter is configured to attach to the transducer housing through a snap-fit engagement.

4. The system according to claim 1, wherein the mount adapter is configured to attach to the transducer housing without fasteners or adhesive bonding.

5. The system according to claim 1 further comprising a transom mounting bracket, wherein the mount adapter is configured to attach to the transom mounting bracket, and wherein the transom mounting bracket is configured to attach to the transom of the boat.

6. The system according to claim 1 further comprising a thru-hull mounting bracket, wherein the mount adapter is configured to attach to the thru-hull mounting bracket, and wherein the thru-hull mounting bracket is configured to mount through the hull of the boat.

7. The system according to claim 1, wherein the upper engagement surface of the housing is further configured to mount a second mount adapter.

8. The system according to claim 1, wherein the mount adapter is configured to mount to a boat.

9. The system according to claim 1, wherein the mount adapter is configured to mount to the hull of a boat.

10. The system according to claim 1, wherein the mount adapter is configured to mount to the transom of a boat.

11. The system according to claim 1, wherein the transducer housing is configured to separably house the at least one transducer.

12. The system according to claim 1, wherein the at least one transducer comprises at least one of a cylindrical transducer, a rectangular transducer, or an elliptical transducer.

13. The system according to claim 1, wherein the at least one transducer comprises more than one transducer.

14. The system according to claim 13, wherein the transducers include transducers of at least two different shapes.

15. A transducer housing configured for interchangeable mounting options for a watercraft, wherein the transducer housing is configured to house at least one transducer; wherein the transducer housing comprises:
at least one upper engagement surface configured to adjacently engage a first mount adapter to facilitate a first type of mounting; and
at least one lower engagement surface configured to adjacently engage a second mount adapter to facilitate a second type of mounting as an alternative to mounting on the transom.

16. The transducer housing according to claim 15, wherein the first mount adapter comprises a transom mount adapter, and wherein the first type of mounting comprises mounting to a transom of a boat.

17. The transducer housing according to claim 15, wherein the second mount adapter comprises a trolling motor mount adapter, and wherein the second type of mounting comprises mounting to a trolling motor.

18. The transducer housing according to claim 15, wherein the transducer housing is configured to removably attach to the first mount adapter without fasteners.

19. The transducer housing according to claim 18, wherein the transducer housing is configured to attach to the first mount adapter through snap-fit engagement.

20. The transducer housing according to claim 15, wherein the at least one upper engagement surface of the transducer housing is configured to slidably engage the first mount adapter.

21. The transducer housing according to claim 15, wherein the at least one upper engagement surface of the transducer housing is further configured to adjacently engage a third mount adapter to facilitate a third type of mounting as an alternative to the first and second type of mounting.

22. The transducer housing according to claim 21, wherein the third mount adapter comprises a portable mount adapter, and wherein the third type of mounting comprises portable mounting to a boat.

23. The transducer housing according to claim 21, wherein the third mount adapter comprises a thru-hull mount adapter, and wherein the third type of mounting comprises a thru-hull mounting to a boat.

24. A system for interchangeable mounting options of a sonar transducer to a boat, the system comprising:
at least one transducer;
a transducer housing configured to house the at least one transducer; and
a trolling motor mount adapter, wherein the transducer housing comprises at least one lower engagement surface configured to adjacently engage the trolling motor mount adapter to facilitate mounting on a trolling motor.

25. The system according to claim 24, wherein the trolling motor mount adapter is configured to removably receive the transducer housing.

26. The system according to claim 24, wherein the trolling motor mount adapter comprises a hole, wherein the hole comprises a perimeter configured to engage the at least one lower engagement surface of the transducer housing such that the transducer housing fits at least partially in the hole.

27. The system according to claim 24, wherein the trolling motor mount adapter comprises an engagement surface configured to receive at least a portion of the transducer housing.

28. The system according to claim 24 further comprising a mounting strap, wherein the trolling mount adapter comprises at least two slots configured to receive the mounting strap, wherein the mounting strap is configured to be threaded through the at least two slots and around the trolling motor to tighten and secure the trolling mount adapter to the trolling motor.

29. The system according to claim 28 further comprising a padding configured to be positioned between the transducer and the trolling motor to at least partially protect the transducer.

30. The system according to claim 24, wherein the trolling motor mount adapter is configured to engage the transducer housing without fasteners or adhesive bonding.

31. A trolling motor mount adapter for a transducer housing configured for interchangeable mounting options for a boat, the trolling motor mount adapter configured to removably receive the transducer housing, wherein the trolling motor mount adapter comprises:
a hole, wherein the hole comprises a perimeter configured to engage the transducer housing such that the transducer housing fits at least partially in the hole.

32. The trolling motor mount adapter according to claim 31, wherein the trolling motor mount adapter comprises an engagement surface configured to receive at least a portion of the transducer housing.
